(19) United States
(12) Patent Application Publication
(10) Pub. No.: US 2011/0114545 A1
(43) Pub. Date: May 19, 2011

(54) DEVICE FOR THE PURIFICATION OF WASTE WATER

(75) Inventors: Marcus Hoefken, Erlangen (DE); Walter Steidl, Burgthann (DE); Peter Huber, Ursensollen (DE)

(73) Assignee: INVENT UMWELT-UND VERFAHRENSTECHINK AG, Erlangen (DE)

(21) Appl. No.: 12/736,968

(22) PCT Filed: May 25, 2009
(86) PCT No.: PCT/EP2009/056310

§ 371 Date: Jan. 18, 2011

(30) Foreign Application Priority Data
May 30, 2008 (DE) 10 2008 026 206.4

(51) Int. Cl. C02F 9/02; B01D 17/00; C02F 3/00; B01D 21/30

(52) U.S. Cl. 210/141; 210/257.1; 210/251; 210/151; 210/202

(57) ABSTRACT

The invention relates to an apparatus for cleaning sewage, having a housing (1) of substantially rectangular outline which is formed in the manner of a transportable container, wherein a plurality of compartments (C1, C2, C3, C4) are provided one behind the other along a longitudinal direction of the outline, wherein a first compartment (C1) contains at least two treatment basins (B1, B2, B3, B4) and an adjoining, second compartment (C2) contains a tank (7) with a lamellar separator (8) and a clarifying basin (9) arranged one after the other downstream of it. In order to improve the cleaning efficiency, it is proposed according to the invention that the clarifying basin (9) be arranged between the lamellar separator (8) and the first compartment (C1).

The invention relates to a device for the purification of waste water according to the preamble of claim 1.

Such a device is known from U.S. Pat. No. 4,687,574. In this connection the waste water moves in succession from an input tank to a first and a second flocculation chamber each of which contains flocculation chemicals. The liquid is then led from the second flocculation chamber over a lamella separator and collected in a clear water container provided downstream. The known device does not have a particularly good purification performance. Moreover, its operation requires that flocculation chemicals be added to the waste water which contaminate the clear water. The use of flocculation chemicals ultimately causes more work.

A further device for the treatment of waste water is known from US 2005/0274669 A1. The device can be integrated in a container and is transportable. To purify waste water, the known device is equipped with a bioreactor which contains a membrane to separate clean water from sludge.

One of the purification plants known from DE 39 29 510 C2 consists of sections each of which contains a plurality of chambers. The chambers can be connected with each other variably with closable openings. The purification plant can thus be adjusted to different amounts of waste water and qualities and operated in single or multiple stages.

A further transportable purification plant is known from DE 295 02 118 U1. It is installed in a container and is equipped with a plurality of containers which can be connected with each other with suitable units based on the particular requirements of use. In this connection, different process stages of waste water processing can be performed.

A device for the treatment of waste water from cesspools is known from WO 03/055808 A1. The device has an inlet channel, a main purifying chamber and an outlet channel.

DE 10 2005 017 948 A1 describes a device for the preparation of waste water from laundries. The device consists of a first mobile container and a second mobile container. One of the containers is used as a storage container and the other one is used as a processing container and is equipped with a bioreactor.

The known transportable devices for the processing of waste water usually do not have a particularly good purification performance.

The object of the invention is to eliminate the disadvantages in accordance with prior art. In particular, a transportable device for the purification of waste water is to be specified which offers an improved purification performance.

This object is resolved by the features of claim 1. Useful embodiments of the invention result from the features of claims 2 to 18.

According to the provisions of the invention, it is provided that the clear water basin is located between the lamella separator and the first section.—The suggested arrangement permits the optimum utilization of the available space which is limited by the form of conventional containers. Due to the suggested arrangement, it is possible to design the processing basin and the lamella separator large and thus particularly effective. With this, an improved purification performance can be achieved in a simple and inexpensive way.

By designing the housing in the form of a transportable container, namely a container of conventional dimensions, the suggested device can be transported inexpensively with conventional transportation means such as truck, ship, airplane, train which are prepared for container transportation. With this, the suggested device is suitable, for example, for use at remote large construction sites, in towns without purification plant, in times of crises and similar.

According to an advantageous embodiment, a current guidance device is provided in the container for the essentially vertical, upward directed loading of the lamella separator. An essentially horizontal current entering the container is turned into an essentially vertical current by the current guidance device. The current guidance device can be essentially horizontally running tubes from which tube connections extend vertically. Instead of the tube connections, the tubes can also just have breakthroughs pointing towards the lamella separator. Other current guidance devices, for example, bent or inclined plates, troughs or canals being directed towards the lamella separator can also be provided.

According to a further embodiment, overflow troughs are provided on an upper end of the lamella separator extending vertically to the longitudinal edges of the lamella which overflow troughs are for collecting and leading off the clear water into the clear water basin. The clear water leaving the upper end of the lamella separator rises up to a level of the side edges of the overflow troughs and proceeds via the side edges into the overflow troughs and from there to the clear water basin. The provided overflow troughs are used for slowing down and equalizing the current similar to the current guidance device. This improves the purification performance of the lamella separator.

According to a further, particularly advantageous embodiment, the clear water basin is provided above the container. This makes the design of the device particularly compact. In this embodiment, the clear water basin is of the approximate size of the container located upstream from the lamella separator, or smaller than the container. The space saved by the suggested embodiment can then be used to provide an enlarged lamella separator and/or enlarged processing basin.

Moreover, it is advantageous to provide a device to radiate the clear water contained in the clear water basin with UV light. This can be used to kill any germs or similar which may have remained in the clear water.

The waste water is biologically purified in the processing basin using suitable bacteria. For this purpose, culture bodies, preferably made of plastic, for bacteria can be put into the processing basin. Such culture bodies are generally known in accordance with prior art. These are loose bodies which can be moved like a fluidized bed by the current in the processing basin.

To increase the efficiency of the purification caused by the bacteria, an aeration device is provided in at least one of the processing basins, preferably in all processing basins.

In this connection, this can be conventional hoses or tubes which have breakthroughs and are supported on the bottom of the processing basin and provided with compressed air. The tubes or hoses as well as the breakthroughs provided therein are arranged in such a manner that as uniform an aeration as possible is achieved in the particular processing basin.

It has been shown to be useful that a third compartment bordering on the first compartment be provided on a first narrow side of the housing in which a conveyor device to convey the waste water to be processed and/or a compressed air generating device to supply the aeration device with compressed air is/are contained. With the conveyor device, this is usefully at least a conventional pump which is suitable for pumping the waste water to be processed.

In accordance with a further embodiment, a fourth compartment on a second narrow side of the housing and bordering on the second compartment can also be provided in which a further conveyor device for conveying the waste water to be processed and/or a further compressed air generating device to supply the aeration device with compressed air is/are contained. The units provided in the fourth compartment are particularly used to generate a suitable current through the lamella separator, to purify the container and/or the lamella separator as well as to pump off clear water and similar.

It has been shown to be useful that at least one door be provided on the first and/or second narrow side for opening the third and/or the fourth compartment. Such doors permit simple access to the third and/or fourth compartment and thus permit particularly easy maintenance and/or repair of the units required to operate the device.

In accordance with a further embodiment, the compartments are separated from one another by first separating walls which essentially run parallel to the narrow sides of the housing. In particular, the first separating walls between the first and third compartment as well as those between the second and fourth compartment do not have breakthroughs. In contrast, the first separating wall between the first and second compartment in the vicinity of the bottom of the housing has one or more breakthroughs for the connection with the container provided in the second compartment.

It has been shown to be useful that the processing basins provided in the first compartment are separated by second separating walls running essentially parallel to the narrow sides of the housing. In this connection, the second separating walls have breakthroughs to conduct the waste water from a processing basin to the next processing basin downstream. In this connection, the breakthroughs are provided in the direction of the current in the next second separating walls alternately in the vicinity of the bottom and in the vicinity of a ceiling of the housing opposite the bottom so that as long as possible a flow through the processing basins is created for the waste water. In addition, the second separating walls have the essential function of separating the processing basins from each other so that it is possible to process the waste water with different bacteria. The device can have two, three, four or even more processing basins.

It has been shown to be useful that the compartments extend over the entire width of the housing. Furthermore, the compartments are thus limited by longitudinal walls of the housing as well as of its bottom.

In accordance with a special embodiment of the invention, it is provided that the clear water basin is limited by a third separating wall which is running essentially parallel to the lamella of the lamella separator and pointing at an angle to the first separating wall located opposite. In its slanted position, the third separating wall corresponds to the shape of the lamella separator. This further increases the compact form of the suggested device.

In accordance with a further advantageous embodiment, a swirling device for swirling sludge is provided in the container. Such a swirling device is then put into operation when the container is to be cleaned. With the swirling device, it has been shown to be useful that this can be a further aeration device. The further aeration device can be subjected to such an air pressure that the sludge located over this is swirled and can be brought into a suspension. The suspension can then be removed through a separately provided disposal opening.

In accordance with a further embodiment, a control device to control the conveyor and/or aeration devices according to a predetermined program is provided. This makes it possible to operate the units contained in the device in a coordinated manner so that the respective waste water to be processed is optimally purified. For example, the program can also contain a “purification mode” with which the sludge in the container can be swirled as necessary and removed from the device.

Finally, closable overhaul hatches can be provided in the ceiling of the housing which is opposite the bottom. Such overhaul hatches permit access to the respective processing basins for repair and/or maintenance purposes.

The invention will now be described in more detail using examples based on the drawings. It is shown:

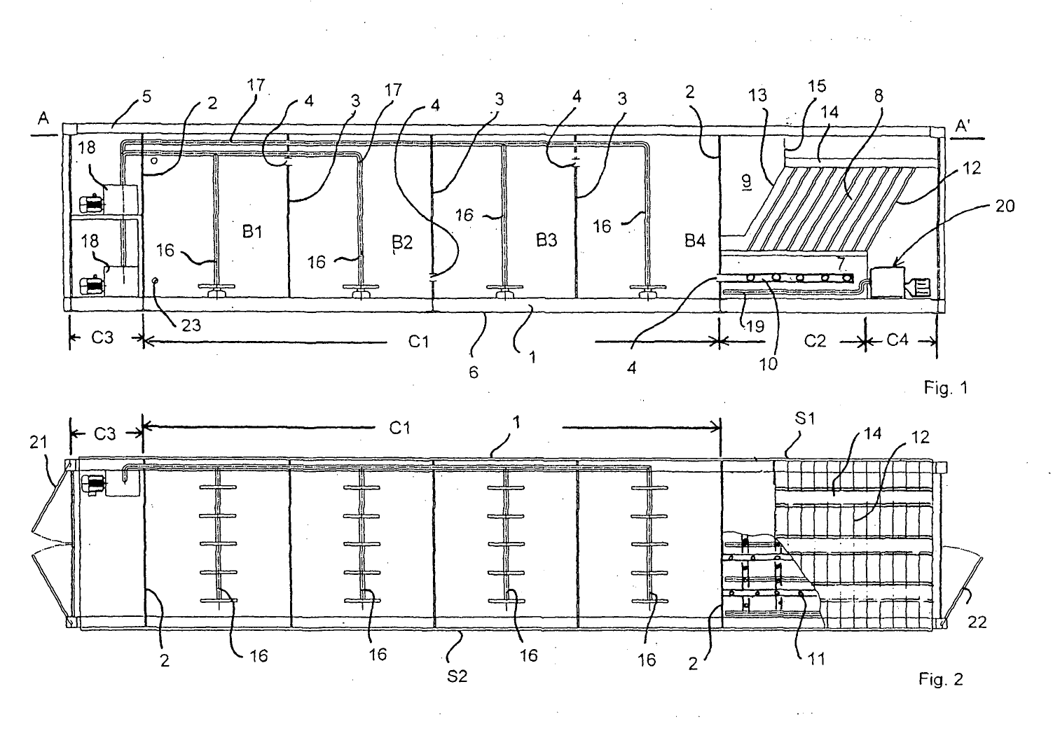

FIG. 1 A schematic longitudinal cross section through a device for the purification of waste water and

FIG. 2 A further cross sectional view in accordance with the intersecting line A-A′ in FIG. 1

With the device shown in FIGS. 1 and 2, a housing 1 is made from a conventional transportable container which, for example, has a length of 40 feet. The housing 1 is divided by first separating walls 2 into a first compartment C1, a second compartment C2, a third compartment C3, and a fourth compartment C4. The compartments C1, C2, C3 and C4 are arranged one after the other in a longitudinal direction of the housing 1. The first compartment C1 consists of a plurality of processing basins divided from each other by second separating walls 3. In this explanatory example, four processing basins B1, B2, B3 and B4 are provided. It is also possible to provide fewer processing basins, for example, two or three, or also more processing basins, for example, five or six. The processing basins B1, B2, B3 or B4 are connected with each other via first breakthroughs 4 provided in the second separating walls 3. In this connection, the first breakthroughs 4 are provided in the following second separating walls 3, alternately in the vicinity of a ceiling 5 and a bottom 6 of the housing 1. With the suggested device, the first compartment C1 occupies an essential area of the housing 1. In other words, the space enclosed by the processing basins B1, B2, B3 and B4 is greater than the second C2, third C3 and fourth compartment C4. The first compartment C1 can have more than twice, preferably more than three times the volume of the second compartment C2. Due to the large volume of the first compartment C1, a particularly complete purification of the waste water succeeds even under difficult climatic conditions, in a desert climate, for example.

The first 2 and/or second separating walls 3 extend advantageously from the one longitudinal wall S1 of the housing 1 up to its other longitudinal wall S2. Due to this, the processing basins B1, B2, B3 and B4 in the device are thus also arranged one after the other in the housing 1 in a current direction of the waste water to be processed.

Downstream from the fourth processing basin B4 a container 7 is provided in the second compartment C2 after which a lamella separator 8 is in turn located downstream. Reference sign 9 indicates a clear water basin located downstream after the lamella separator 8. The clear water basin 9 is located above the container 7 in the second compartment C2 and is next to the first compartment C1.

A current guidance device 10 is provided in the container 7 with which device the waste water loaded with sludge and flowing out of the fourth processing basin B4 is diverted to an essentially vertical current direction. With the current guidance device 10, this can be tubes, perforated metal or guide plates or canals which extend in the longitudinal direction in the container 7. They can be connected with one another via cross lines and have second breakthroughs 11 which open in the direction of the lamella separator 8.

The lamella separator 8 comprises a plurality of lamella 12 arranged in parallel whose edges are arranged essentially parallel to the first separating walls 2. The lamella 12 are slanted in relation to a vertical direction so that the clear water basin 9 is limited by a third separating wall 13 running essentially parallel to the lamella 12. Reference sign 14 indicates overflow troughs extending on the upper end of the lamella separator 8 vertical to the longitudinal edges of the lamella 12, which overflow troughs are provided to collect and lead off the clear water to the clear water basin 9. A fourth separating wall 15 ensures that the clear water coming out of the lamella 12 is only led out via the overflow troughs 14 into the clear water basin 9.

Above the lamella an overhaul hatch (not shown here) can be provided in the ceiling 5 of the housing 1 through which hatch the preferably detachably arranged lamella 12 and/or the overflow troughs 14 can be taken out for cleaning, for example.

In each of the processing basins B1, B2, B3 and B4 is provided an aeration device 16 which is comprised of longitudinal and cross lines arranged in the vicinity of the bottom 6. The longitudinal and cross lines have breakthroughs (not shown here) pointing to the ceiling 5 which allow air to escape. The aeration devices 16 are connected via air inlet lines 17 with compressed air generating devices 18 which, for example, are contained in the third compartment C3.

Moreover, the third compartment C3 can contain at least one (not shown here) pump to convey the waste water to be processed from the first processing basin B1 in the direction of the clear water basin 9. The second compartment C2 contains a further aeration device 19 which is connected with a further compressed air generating device 20. The further compressed air generating device 20 can be located in the fourth compartment C4. Reference sign 21 indicates first doors through which the third compartment C3 is accessible. In this connection, this can be a conventional door provided for a container. Reference sign 22 indicates a second door which permits access to the fourth compartment C4. The terminal third C3 and fourth compartments C4 provided at the end of the narrow sides of the housing 1 ensure easy accessibility to the units arranged there to maintain device operation.

The ceiling 5 of the housing 1 can be provided with (not shown here) overhaul hatches to access the processing basins B1, B2, B3, B4 of the clear water basin 9 as well as the lamella separator 8. Moreover, a device for radiating (not shown here) the clear water in the clear water basin 9 with UV light can be provided.

The function of the device is described below:

The waste water to be processed is pumped through an inlet opening designated with reference sign 23 into the first processing basin B1. Culture mediums for bacteria (not shown here) are located in all processing basins B1, B2, B3 and B4. In this connection, these are conventional plastic bodies which are freely mobile and swim around in the waste water to be processed. The plastic bodies form a fluidized bed which is kept in motion by the aeration device 16. After a specified period of time, the thus processed waste water moves from the first processing basin B1 to the second B2, then to the third B3 and then to the fourth processing basin B4. In this connection, the waste water is subsequently subjected to a plurality of purification stages. In the fourth processing basin B4, the waste water is almost free of organic impurities. The sludge remaining in the waste water is separated by the lamella separator 8 installed downstream. The remaining clear water is collected in the clear water basin 9. Any remaining microbial impurities can be killed there with a device for radiating with UV light.

To remove the sludge which settled in the container 7, this can be drawn off with a (not shown here) sludge remover tube with the help of a (also not shown here) sludge removal pump. The sludge can be drawn off at specified intervals. It has been shown to be useful that the sludge removal pump be located in the fourth compartment C4.

With the further aeration device 19, it is possible to swirl the sludge located on the lamella 12 and remove it. The thus created sludge-filled water can be led off via the overflow troughs 14 and via a (not shown here) special sludge line.

Both the sludge drawn off from the bottom of the container 7 and the sludge removed via the sludge line can be returned to the processing basins B1 to B4. For this purpose, a special (not shown here) return sludge pump can be provided which, for example, can be provided in the fourth compartment C4.

The suggested device for the purification of waste water is designed particularly compactly. By locating the clear water basin 9 between the lamella separator 8 and the first compartment C1, the space gained by this can be used to enlarge the lamella separator 8 and/or the processing basins B1, B2, B3, B4. Due to this, the suggested device for the purification of waste water offers a particularly high purification performance.

The components of the device previously designated as “separating walls” not only have the function of separating processing basins or compartments from each other, but also the function of stiffening the housing. For this purpose, the separating walls can be appropriately stiffened, for example, with bars and/or a suitable thick material.

### LIST OF REFERENCE SIGNS

1 Housing
2 First separating wall
3 Second separating wall
4 First breakthrough
5 Ceiling
6 Bottom
7 Container
8 Lamella separator
9 Clear water basin
10 Current guidance device
11 Second breakthrough
12 Lamella
13 Third separating wall
14 Overflow trough
15 Fourth separating wall
16 Aeration device
17 Air inlet line
18 Compressed air generating device
19 Further aeration device
20 Further compressed air generating device
21 First door
22 Second door
23 Inlet opening
B1, B2, B3, B4 Processing basins
C1 First compartment
C2 Second compartment
C3 Third compartment
C4 Fourth compartment
S1 Longitudinal wall
S2 Other longitudinal wall

1-18. (canceled)

19. Device for the purification of waste water,
with a housing (1) shaped in the form of a transportable container having an essentially rectangular layout,
wherein a plurality of compartments (C1, C2, C3, C4) are provided one after the other along a longitudinal direction of the layout,
wherein, at least two processing basins (B1, B2, B3, B4) are provided in a first compartment (C1) and one container (7) is provided in an adjacent second compartment (C2), a lamella separator (8) having a plurality of parallel lamella (12) and a clear water processing basin are located in succession downstream after said container (7),
wherein the clear water basin (9) is located between the lamella separator (8) and the first compartment (C1),
characterized in that
overflow troughs (14) for collecting and leading off the clear water into the clear water basin (9) are provided, which overflow troughs (14) are located at an upper end of the lamella separator (8) and extend vertically to the longitudinal edges of the lamella (12), and wherein moreover a fourth separating wall (15) is provided with which it is ensured that the clear water leaving the lamella (12) is only led away to the clear water basin (9) via the overflow troughs (14).

20. Device as defined in claim 19, wherein a current guidance device (10) is provided in the container (7) for the essentially vertical, upward directed loading of the lamella separator (8).

21. Device as defined in claim 19, wherein a device for radiating with UV light the clear water contained in the clear water basin (9) is provided.

22. Device as defined in claim 19, wherein culture bodies for bacteria, preferably made of plastic, are contained in the processing basins (B1, B2, B3, B4).

23. Device as defined in claim 19, wherein an aeration device (16) is provided in at least one of the processing basins (B1, B2, B3, B4).

24. Device as defined in claim 19, wherein, on a first narrow side of the housing (1), a third compartment (C3) bordering on the first compartment (C1) is provided in which a conveyor device to convey the waste water to be processed and/or a compressed air generating device (18) to supply the aeration device (16) with compressed air is/are contained.

25. Device as defined in claim 19, wherein, on a second narrow side of the housing (1), a fourth compartment (C4) bordering on the second compartment (C2) is provided in which a further conveyor device to convey the waste water to be processed and/or a further compressed air generating device (20) to supply the aeration device (16) or a further aeration device (19) with compressed air is/are contained.

26. Device as defined in claim 19, wherein, on the first and/or second narrow side, at least one door (21, 22) for opening the third (C3) and/or fourth compartment (C4) is provided.

27. Device as defined in claim 19, wherein the compartments (C1, C2, C3, C4) are separated from one another by first separating walls (2) running essentially parallel to the narrow sides of the housing (1).

28. Device as defined in claim 19, wherein the processing basins (B1, B2, B3, B4) provided in the first compartment (C1) are separated from one another by second separating walls (3) running essentially parallel to the narrow sides of the housing (1).

29. Device as defined in claim 19, wherein furthermore the compartments (C1, C2, C3, C4) are limited by longitudinal walls (S1, S2) of the housing (1) and its bottom (6).

30. Device as defined in claim 19, wherein the clear water basin (9) is limited by a third separating wall (13) running essentially parallel to the lamella (12) of the lamella separator (8) and pointing at an angle to the first separating wall (2) located opposite.

31. Device as defined in claim 19, wherein a swirling device to swirl the sludge is provided in the container (7).

32. Device as defined in claim 19, wherein the swirling device is the further aeration device (19).

33. Device as defined in claim 19, wherein a control device for controlling the conveyor and/or aeration devices (16, 19) according to a predetermined program is provided.

34. Device as defined in claim 19, wherein closable overhaul hatches are provided in a ceiling (5) opposite the bottom (6) of the housing (1).
